(19) United States
(12) Patent Application Publication
(10) Pub. No.: US 2009/0158777 A1
(43) Pub. Date: Jun. 25, 2009

(54) Method and Device for Recycling Mineral Wool Waste Containing Organic Components

(76) Inventors: Thomas Tenzler, Untermeitingen (DE); Jorg-Michael Krichel, Landsberg-Erpfting (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/332,042

(22) Filed: Dec. 10, 2008

(30) Foreign Application Priority Data
Dec. 19, 2007 (EP) EP 07 024 626.9

(51) Int. Cl. C03B 5/00; C03B 3/00

(52) U.S. Cl. 65/134.4; 65/157

(57) ABSTRACT

Method for recycling mineral wool waste containing organic components, comprising the steps of:
feeding the mineral wool waste into a charging device of a melting or preheating aggregate of a glass melting furnace;
feeding an oxygen-containing gas flow into the charging device to generate an oxygen-rich atmosphere in said charging device;
combusting the organic components in said charging device.

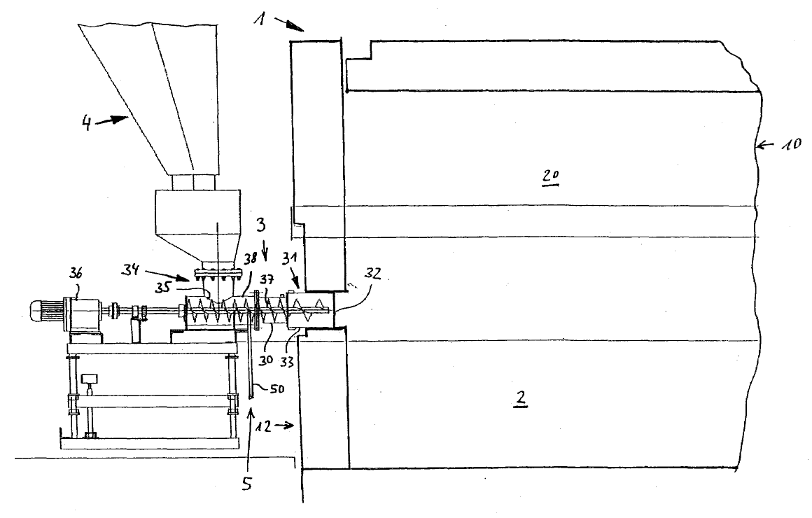

The invention relates to a method for recycling mineral wool waste containing organic components as well as a device for carrying out this method.

Mineral wool waste, particularly glass-fiber waste or glass-wool waste, is frequently contaminated with binders or other organic substances. These organic impurities have to be removed prior to adding the mineral wool waste to a glass melt. For this purpose, a separate recycling method is often used before the actual melting process, in which the mineral wool waste is first heated to a temperature, at which the organic impurity components combust and can escape as exhaust gas. However, especially during recycling of glass-fiber and glass-wool materials there is the risk that the glass-fiber material or the glass-wool material sinters during the combustion process of the organic components. Sintered material of such a type, however, has a disposition to rapidly clog the melting furnaces used for recycling, in particular cyclone and rotary furnaces.

Known from US 2002/0000100 A1 is a method and a device for feeding mineral wool waste to a glass melt, in which mineral wool waste is added in doses to a glass melt flowing out of a glass melting furnace, where said mineral wool waste also melts due to the temperature prevalent in the glass melt and mixes with the glass melt.

WO 2006/018582 A1 discloses a method and a device for recycling fiberglass waste, in which a closed incinerator furnace is provided in its bottom region with gas burners protruding upwards from the bottom as well as with oxygen-feed openings provided in the bottom. Fiberglass waste is poured onto the bottom where it forms a fiberglass-waste pile covering both the oxygen-feed openings and the gas burners. During the heating of the fiberglass waste by the gas burners, oxygen is added in doses through the oxygen-feed openings. The fiberglass waste melts to a liquid film which flows out of the furnace through a discharge opening.

The object of the present invention is to provide a method and a device for recycling mineral wool waste containing organic components, which overcome the disadvantages of the prior art and allows an efficient recycling of the mineral wool waste as well as a feeding of the mineral wool waste to a glass melt.

The object regarding the method is solved by the method given in claim 1. The mineral wool waste is first fed into a charging device of a melting or preheating aggregate of a glass melting furnace. An oxygen-containing gas flow is then fed into the charging device to generate an oxygen-rich atmosphere in the charging device. Thereupon, the organic components are combusted in the charging device. Hence, there is no recycling step carried out separately from the actual melting of the glass, and the recycling process for removing the organic components is carried out directly in the charging device of the melting or preheating aggregate of the glass melting furnace, by means of which the raw material is fed into the glass melt. By feeding the oxygen-containing gas flow into the charging device, the combustion of the organic components in the feed screw can take place during the conveyance step of the mineral wool waste into the glass melting furnace.

This method is advantageous for mineral wool waste consisting of binder-containing mineral fibers or predominantly containing such fibers. The mineral fibers can contain glass-wool and/or rock-wool fibers.

An embodiment of the method is preferred, in which the weight percentage proportion of the organic components of the mineral wool waste ranges between 2% and 25%, particularly preferred between 3% and 10%.

In another embodiment of the method the mineral wool waste is fed either in pure form or mixed with batches and/or fragments, the weight concentration of the mineral wool waste in the charging device ranging from 0.5% to 100%. Glass batches and/or glass fragments are thus added to the mineral wool waste consisting of binder-containing mineral fibers (e.g. glass-wool or rock-wool fibers).

The oxygen content of the gas flow is preferably in the range between 18% and 100%. Ambient air having an oxygen content of 20% can, for example, be used thereby. Alternatively, the gas flow can also consist of industrial oxygen, preferably having an oxygen content between 90% and 100%.

The method can be particularly well realized if a screw charger or a piston charger is used as charging device.

Advantageously, the oxygen-containing gas flow is fed into the charging device at a location behind a feed opening and before entering the glass melting furnace.

The pressure of the oxygen-containing gas flow in the charging device is preferably higher than the pressure in the melting or preheating aggregate such that there is an over-pressure in the charging device. This overpressure is preferably between 1 mbar and 2 bar, particularly preferred is between 1 mbar and 100 mbar.

The chemical composition of the inorganic phase of the mineral wool waste can contain the following components: SiO₂, Al₂O₃, CaO, MgO, Na₂O+K₂O, B₂O₃, P₂O₅ and/or Fe₂O₃.

The chemical composition of the inorganic phase of the waste comprises, e.g., the following weight percentages of different chemical substances:

| | |
|---|---|
| SiO₂ | 35% to 70% |
| Al₂O₃ | 0% to 27% |
| CaO | 4% to 20% |
| MgO | 0% to 6% |
| Na₂O + K₂O | 0% to 20% |
| B₂O₃ | 0% to 10% |
| P₂O₅ | 0% to 5% |
| Fe₂O₃ | 0% to 15% |
| other oxides | 0% to 5%. |

The part of the object regarding the device, which forms the basis for the present invention, is solved by the features of claim 15. The device according to the invention for recycling mineral wool waste containing organic components comprises a glass melting furnace and a charging device for feeding the mineral wool waste into the glass melting furnace and is characterized in that the charging device is provided with a gas delivery device through which an oxygen-containing gas flow can be fed into the charging device.

Preferably, the charging device charges a melting aggregate of the glass melting furnace with the mineral wool waste. Alternatively, the charging device can also charge a preheating aggregate of the glass melting furnace with the mineral wool waste.

In a preferred embodiment, the charging device is formed as a screw charger and comprises a feed hopper for the charge of the screw charger with the mineral wool waste.

It is advantageous if the gas delivery device opens into the charging device between the feed hopper and the screw charger.

The gas delivery device can, however, also open into the head of the charging device, e.g. in the region of a water cooling ring surrounding the head.

The invention will be explained in more detail below by way of an example and with reference to the drawing. In this drawing, the only FIGURE shows a schematic illustration of the device according to the invention.

The FIGURE schematically shows a glass melting furnace 1 having a melting aggregate 10 that is heated in a conventional manner to a temperature which is above the melting temperature of glass. A glass melt 2 is thus formed in the melting aggregate 10 of the glass melting furnace 1 in the tub-like case body 12 of the melting aggregate 10.

A charging device 3, formed as a screw charger having a feed screw 37 driven by a motor 36 and rotatably provided in a cylinder jacket 38, is attached to the glass melting furnace 1 in such a manner that the outlet of the screw charger 30 disposed on the head 31 of the charging device 3, the screw charger 30 extending horizontally in the FIGURE, opens into the melting aggregate 10 above the glass melt 2, said head 31 being surrounded by a water cooling ring 33. In the region of its end portion facing away from this opening 32, the screw charger 30 is connected to a feed hopper 34, from which mineral wool waste can be poured through a feed opening 35 of the charging device into the screw charger 30. The FIGURE shows, above the feed hopper 34, a pouring and silo device 4 for mineral wool waste, which is connected at its lower end to the feed hopper 34.

A gas delivery device 5 merely shown schematically as a line 50 in the FIGURE opens into the screw charger 30 between the feed hopper 34 and the head 31 of the charging device 3. The line 50 of the gas delivery device 5 is, at its other end, connected to a pressurized gas tank (not shown) which contains an over-pressurized oxygen-rich gas mixture.

The mineral wool waste poured into the feed hopper, which predominantly consists of glass wool and/or rock wool and can also contain batches and fragments, is already flown-through in the screw charger 30 by the oxygen-rich gas mixture fed into the charging device 3 through the gas delivery device 5. Due to the overpressure, the oxygen-rich gas mixture enters further into the screw charger 30, by which an oxygen-enriched atmosphere develops in the screw charger 30. Through the opening 32 of the screw charger 30, heat enters as heat radiation and convection from the glass melting furnace 1 into the screw charger 30 such that due to this heat and the oxygen-enriched atmosphere organic components in the mineral wool waste are combusted in the screw charger. The combustion gases pass out from the opening 32 into the upper structure atmosphere 20 above the glass melt 2, and the mineral wool waste freed of the organic components falls into the glass melt 2, where it is melted.

The organic components in the mineral wool waste are thus already combusted for the most part at an early stage in the oxygen-rich environment locally produced in the screw charger 30. The organic components originally contained in the mineral wool waste consequently no longer have an interfering effect on the characteristics of the glass melt since they no longer penetrate into the glass melt. The low-temperature gases possibly arising during the combustion processes in the screw charger 30, which enter into the upper structure atmosphere 20, are rendered harmless by the high temperatures in the upper structure atmosphere 20.

This embodiment according to the invention is also advantageous in that, due to the recycling process being performed in the charging device 3 directly on the glass melting furnace 1, no additional energy has to be supplied for the combustion process of the organic components since the radiant heat and convection heat emitting from the glass melting furnace are sufficient to initiate and perform the combustion process.

If no oxygen-enriched gas mixture is supplied for acceleration of the combustion process in the screw charger 30, but simple ambient air, the oxidation process occurring during combustion is perhaps not as efficient as when oxygen-enriched gas mixture is supplied, however—as was already explained above—possibly occurring low-temperature gases are rendered harmless due to the high temperatures in the upper structure atmosphere. Due to this, significantly larger amounts of organically contaminated mineral wool waste, e.g. glass fibers, can be recycled in the glass melting furnace 1 without additional oxygen having to be added.

The invention is not limited to the exemplary embodiment given above, which merely explains the central idea of the invention in a general manner. The device according to the invention can rather also have, within the scope of protection, embodiments other than those described above. The device can particularly have features which are a combination of the respective individual features of the claims.

Reference numbers in the claims, the description and the drawing are merely used for better understanding of the invention and should not restrict the scope of protection.

1. Method for recycling mineral wool waste containing organic components, comprising the steps of:
feeding the mineral wool waste into a charging device of a melting or preheating aggregate of a glass melting furnace;
feeding an oxygen-containing gas flow into the charging device to generate an oxygen-rich atmosphere in said charging device;
combusting the organic components in said charging device.

2. The method according to claim 1, characterized in that
the mineral wool waste consists of binder-containing mineral fibers.

3. The method according to claim 2, characterized in that
the mineral fibers contain glass-wool and/or rock-wool fibers.

4. The method according to one of claims 1 to 3, characterized in that
the weight percentage proportion of the organic components of the mineral wool waste ranges between 2% and 25%, preferably between 3% and 10%.

5. The method according to one of claims 1 to 3, characterized in that
the mineral wool waste is fed either in pure form or mixed with batches and/or fragments, the weight percentage concentration of the mineral wool waste in the charging device ranging from 0.5% to 100%.

6. The method according to claim 1, characterized in that
the gas flow has an oxygen content of between 18% and 100%.

7. The method according to claim 6, characterized in that
the gas flow is ambient air having an oxygen content of 20%.

8. The method according to claim 6, characterized in that
the gas flow is industrial oxygen, preferably having an oxygen content between 90% and 100%.

9. The method according to claim 1, characterized in that
a screw charger is used as charging device.

10. The method according to claim 1, characterized in that
a piston charger is used as charging device.

11. The method according to claim 1, characterized in that
the oxygen-containing gas flow is fed into the charging device at a location behind a feed opening and before entering the glass melting furnace.

12. The method according to claim 1, characterized in that
the pressure of the oxygen-containing gas flow in the charging device is higher than the pressure in the melting or preheating aggregate such that there is an over-pressure in the charging device.

13. The method according to claim 12, characterized in that
the overpressure is between 1 mbar and 1 bar, preferably between 1 mbar and 100 mbar.

14. The method according to claim 13, characterized in that
the chemical composition of the inorganic phase of the mineral wool waste contains the following components:
SiO₂, Al₂O₃, CaO, MgO, Na₂O+K₂O, B₂O₃, P₂O₅ and/or Fe₂O₃.

15. Device for recycling mineral wool waste containing organic components, having a glass melting furnace (1) and a charging device (3) for feeding the mineral wool waste into the glass melting furnace (1),
characterized in that
the charging device (3) is provided with a gas delivery device (5) through which an oxygen-containing gas flow can be fed into the charging device (3).

16. The device according to claim 15, characterized in that
the charging device (3) charges a melting aggregate (10) of the glass melting furnace (1) with the mineral wool waste.

17. The device according to claim 15, characterized in that
the charging device (3) charges a preheating aggregate of the glass melting furnace (1) with the mineral wool waste.

18. The device according to claim 15, characterized in that
the charging device (3) is formed as a screw charger (30) and is provided with a feed hopper (34) for charging the screw charger (30) with the mineral wool waste.

19. The device according to claim 18, characterized in that
the gas delivery device (5) opens into the screw charger (30) between the feed hopper (34) and the head (31) of the charging device (3).

20. The device according to claim 18, characterized in that
the gas delivery device (5) opens into the charging device (3) at the head (31) of the charging device (3).
